(19) United States
(12) Patent Application Publication
(10) Pub. No.: US 2024/0051377 A1
(43) Pub. Date: Feb. 15, 2024

(54) Door Bodyshell of a Framed Door of a Motor Vehicle and Production Method Thereof

(71) Applicant: Bayerische Motoren Werke Aktiengesellschaft, Muenchen (DE)

(72) Inventors: Dominik HOELZEL, Olching (DE); Sebastian RITTMEIER, Baldham (DE)

(21) Appl. No.: 18/283,841

(22) PCT Filed: Nov. 4, 2022
(86) PCT No.: PCT/EP2022/080759

§ 371 Date: Sep. 25, 2023

(30) Foreign Application Priority Data
Nov. 18, 2021 (DE) 10 2021 130 185.8

(51) Int. Cl. B60J 5/04

(52) U.S. Cl. CPC B60J 5/0469; B60J 5/0413; B60J 5/0426

(57) ABSTRACT

A door bodyshell of a framed door of a motor vehicle is provided. The door bodyshell includes a door inside panel and an assembly fastened to the door inside panel. The door inside panel has an inner sill region and a peripheral frame structure, which is connected to the inner sill region, for a motor vehicle side window. The assembly fastened to the door inside panel has a reinforcing structure, which is arranged level with the inner sill region, and a door outside skin, which is connected to the reinforcing structure level with the inner sill region by way of a flange or a welded joint. In a state in which the door body shell is installed on the motor vehicle, the reinforcing structure level with the inner sill region is inclined in the direction of a motor vehicle interior such that the flange or the welded joint and a horizontal plane enclose an angle of less than 90°. In the state in which the door body shell is installed on the motor vehicle, the flange or the welded joint is formed as far as at least an outer comer, in the longitudinal direction of the motor vehicle, of an outer sill region of the door body shell.

### BACKGROUND AND SUMMARY

The present invention relates to a door bodyshell of a framed door of a motor vehicle and to a production method for such a door bodyshell.

A distinction is generally made in the case of motor vehicle side doors between frameless doors, which are routinely used in cabriolets and coupes, and framed doors. In frameless doors, a frame surrounding the window pane of the door is omitted.

DE 10 2004 018 745 B4 describes, for example, a body structure of a passenger car, in particular a cabriolet. The body structure comprises at least one frameless side door on each vehicle longitudinal side, wherein, in its closed position, the at least one door interacts with adjoining fixed body pillars via hinges on the one hand and via a lock device on the other hand. In order to ensure that, in a body structure of a passenger car, in particular a cabriolet provided with a rear engine, the crash behavior of the body structure is improved in the event of a frontal crash, there is provision that a supporting device, which acts in the event of a frontal crash and keeps the side door in its closed position, is provided between the rear edge of the at least one side door and the adjoining lock-side body pillar, and that the side door is stiffened approximately level with this supporting device by means of a hollow member extending in the vehicle longitudinal direction.

In automobiles, the frame of a framed door extends, starting from a beltline region of the framed door, first along an A-pillar or C-pillar and a B-pillar and then in a roof region along a roof edge of a vehicle body of the automobile. In a closed state of the window pane, the frame receives both ends of the window pane in a motor vehicle longitudinal direction and the upper end, in the motor vehicle vertical direction, of the window pane. Together with the beltline region of the framed door, the frame thus peripherally encloses an opening provided for the window pane of the framed door.

Such a framed door is described, for example, in WO 2009/077069 A1. This relates to a side door for a car, in particular for a passenger car, having an inner door part which comprises a frame part made of a cast material and bears an outer covering part. The inner door part is formed in one piece by the frame part itself.

Irrespective of whether a framed door or a frameless door is concerned, sealing of a window well of the side door of the motor vehicle should be carried out on an outer side thereof. This sealing conventionally occurs by means of an externally visible cover element which ensures the sealing between the window pane and a door bodyshell of the side door. For various reasons, in particular to meet a design specification, this cover element, which is also referred to as a well covering, should, in modern motor vehicles, be as far as possible externally nonvisible to an observer of the motor vehicle. In the case of the above-described generic frameless side doors for motor vehicles, this can partly already be implemented since nonvisible sealing between the window pane and the door bodyshell can be realized there, without a tool colliding with the above-described frame in a production method for the side door.

Against the background of this prior art, the object of the present invention provides a device and a method which are each suitable for overcoming at least the aforementioned disadvantages of the prior art.

The object is achieved by the features of the independent claims. The dependent claims contain preferred developments of the invention.

Accordingly, the object is achieved by a door bodyshell of a framed door of a motor vehicle.

In the present case, a door bodyshell is to be understood as meaning the state of the motor vehicle side door after joining together the components described below, that is to say that the door bodyshell does not yet comprise any attachment parts of the motor vehicle interior, such as, for example, padding and a handle on a door inner side, which are mounted only in a subsequent mounting or production step. The invention is not limited here to this state, that is to say that a motor vehicle side door comprising the above-described door bodyshell can also be provided. Additionally or alternatively, a motor vehicle having the door bodyshell can be provided.

The door bodyshell comprises an inner door panel having an inner beltline region and a peripheral frame structure, which is connected to the inner beltline region, for a motor vehicle side window.

The inner door panel can be an assembly, that is to say a component assembled, in particular joined together, from a plurality of components. Here, this assembly can comprise, in addition to the inner door panel itself, a closure panel, a hinge carrier and/or a reinforcing structure for an outer door skin. This assembly can also be referred to as assembly-inner door panel.

The frame structure can also be referred to as a window frame. The frame structure can have two vertical parts extending upwardly from the inner beltline region that are connected to one another by a further part extending at least partially along a roof of the motor vehicle. The inner door panel itself and in particular the frame structure can be configured in one piece, in particular by deep-drawing.

The door bodyshell further comprises an assembly, which is fastened to the inner door panel, having a reinforcing structure, which is arranged level with the inner beltline region, and an outer door skin, which is connected to the reinforcing structure level with the inner beltline region in particular by means of a flange or a welded joint.

This assembly can also be referred to as assembly-outer door skin which, in addition to the outer door skin or the externally visible vehicle body part of the door bodyshell, has the reinforcing structure, which can also be referred to as reinforcing structure-beltline.

In a state in which the door bodyshell is installed on the motor vehicle, the reinforcing structure is inclined level with the inner beltline region in the direction of a motor vehicle interior such that the flange or the welded joint and a horizontal plane enclose an angle of less than 90°, in particular less than 60°.

In the state in which the door bodyshell is installed on the motor vehicle, the flange or the welded joint is formed as far as in at least an outer corner, in the motor vehicle longitudinal direction, of an outer beltline region of the door bodyshell in which in particular the vertically extending parts of the frame structure are arranged.

The inner beltline region is arranged in the motor vehicle width direction inside the motor vehicle interior delimited outwardly by a window pane of the motor vehicle side window, and the outer beltline region is arranged outside the motor vehicle interior.

As described above, the flange or the welded joint is arranged level with the inner beltline region. This can be understood to mean that the flange or the welded joint is arranged in a region which, starting from the inner beltline region, extends 70 mm upward and/or downward, in particular 35 mm upward and/or downward.

That is to say that a two-part construction of a framed door described at the outset, in particular a side door, of a motor vehicle is proposed. This two-part construction, in which two initially separate components, that is to say the above-described assembly comprising the outer door skin and the inner door panel, are present, makes it possible to form a flange edge or a weld seam along a substantially complete or total length of the outer door skin. The flange edge or the weld seam can be formed before the assembly comprising the outer door skin is connected to the inner door panel. More specifically, the outer door skin can be folded or flanged around the reinforcing structure, or the outer door skin can be connected to the reinforcing structure by welding, without a tool used for this purpose colliding with the frame of the inner door panel. Thus, a horizontal or inclined flange or a horizontal or inclined welded joint can be provided, that is to say a flange or a welded joint which is inclined in the direction of the window pane of the framed door. Here, the flange or the welded joint is also formed in the outer edge regions, in the motor vehicle longitudinal direction, of the outer door skin, in which regions the A-pillar or C-pillar and the B-pillar of a motor vehicle body are situated. This would not be possible in the case of a conventional door bodyshell, since a two-part construction of the door bodyshell is not present and the outer door skin could thus not be folded or flanged or welded in the edge region of the outer door skin without spacing apart the flange or the welded joint from the frame of the door bodyshell in a motor vehicle width direction to such an extent that the flanging tool or the welding tool no longer collides with the frame in this region. This would lead to a widened window well and a high-quality viewing surface could not be achieved, which would not only miss a design target image but would also have to be sealed only with great effort. It would then also not be possible here to manage without a well covering. By contrast, the horizontal flange or the horizontal welded joint makes it possible to arrange a seal of the window pane and the door bodyshell below the flange or the weld seam, that is to say in a window well of the door bodyshell, with the result that this seal is not visible from outside.

Preferred developments of the above-described door bodyshell will be described in detail below.

In the state in which the door bodyshell is installed on the motor vehicle, the outer door skin can upwardly delimit the outer beltline region in a motor vehicle vertical direction.

That is to say that the outer door skin can, at beltline level, be the surface which delimits in the motor vehicle vertical direction. As explained above, the seal of the window pane and door bodyshell can be arranged or installed below the flange or the welded joint, that is to say in a window well of the door bodyshell, such that this seal is not visible from outside. The cover element or the well covering above the outer door skin can then be dispensed with, with the result that the outer door skin is upwardly the delimiting component and no cover element adjoins the outer door skin.

In the state in which the door bodyshell is installed on the motor vehicle, the reinforcing structure can be shorter than the outer door skin in the motor vehicle longitudinal direction.

That is to say that the reinforcing structure-beltline can be slightly shorter than the outer door skin, in particular by at most 30 mm each side. This offers the advantage that shaping of the outer door skin and a subsequent bodyshell process for the door can occur substantially without compression or pressing of the outer door skin.

The door bodyshell can have a seal which can be brought into sealing contact with a window pane. In the state in which the seal is in sealing contact with the window pane, the seal can close, in particular seal, a window well in the outer beltline region. Thus, ingress of dirt into the window well, even without well covering, can be prevented.

Also provided is a production method for the above-described door bodyshell which is characterized in that it comprises provision of the inner door panel and of the assembly comprising the outer door skin, and fastening of the assembly comprising the outer door skin to the inner door panel.

In other words, during the production of the door bodyshell, first of all the two components, that is to say the inner door panel and the assembly comprising the outer door skin, are provided separately from one another and then connected to one another. More specifically, it is only after the provision of the inner door panel and the assembly, which already has the horizontal flange or the horizontal welded joint before connection to the inner door panel, that the assembly is fastened to the inner door panel.

What has been described above with respect to the door bodyshell also applies analogously to the production method thereof described here, and vice versa. Preferred developments of the above-described production method will be described in detail below.

The provision of the assembly comprising the outer door skin can comprise flanging of the outer door skin around the reinforcing structure or welding of the outer door skin to the reinforcing structure with the formation of a welded joint.

In the present case, flanging can be understood to mean bending of the outer door skin in the region of the horizontally extending inner beltline through substantially 180° around the reinforcing structure, with the result that the outer door skin clamps in the reinforcing structure and thus a form-fitting and, where appropriate, force-fitting connection between the outer door skin and the reinforcing structure is produced. Flanging can occur in particular in a robot-based manner, wherein a robot head bends the outer door skin in the region of the inner beltline through substantially 180° around the reinforcing structure. Here, for example, use can be made of a roller folding head on the robot head.

In the present case, welding can be understood as meaning, in particular robot-based, production of a substantially nonreleasable connection of components using heat and/or pressure, with or without welding filler materials. In particular, use can be made of laser welding in which, by means of a laser beam, an increase in a temperature beyond the melting temperature of the metal is achieved on one or both components to be welded, thereby forming a melt, which, after hardening, interconnects the two components to be welded.

The outer door skin can be set off through more than 90° at its corners and/or be coated with PVC at its corners. It is conceivable that stamped edges on the outer door skin are rounded at the corners.

The provision of the assembly can comprise providing an adhesive between the outer door skin and the reinforcing structure in the region of the flange or the welded joint, and/or providing a flanged edge fixing. Both the adhesive and the flanged edge fixing prevent a lateral movement of the outer door skin relative to the reinforcing structure before joining the assembly comprising the outer door skin to the inner door panel.

The flanged edge fixing can be realized, for example, by a welded joint between the outer door skin and the reinforcing structure, which is in particular arranged at one or both ends in the motor vehicle longitudinal direction of the reinforcing structure. It is conceivable that use is made of the above-described laser welding here.

The connection of the inner door panel to the assembly comprising the outer door skin can comprise applying an adhesive to the inner door panel and/or the assembly comprising the outer door skin level with the inner beltline region, and joining, in particular welding, the assembly to the inner door panel, with the result that the assembly is fixed relative to the inner door panel until the adhesive is cured and the assembly is fastened to the inner door panel by means of an adhesive bond.

In the present case, at least the two parts to be joined, with geometrically defined shape, are thus permanently connected, that is to say joined. Moreover, in the present case, a shapeless substance, here adhesive, is used in order to interconnect the two parts to be joined.

The joining can comprise one-sided joining and the inner door panel can have at least one opening, with the result that a joining means for the one-sided joining can be reached through the at least one opening.

That is to say that the door bodyshell, which in turn is itself an assembly, can be formed by means of a one-sided joining method, in particular by means of screwing and/or riveting, between the inner door panel and the assembly comprising the outer door skin.

The reinforcing structure can comprise at least one tab and the connection of the inner door panel to the assembly comprising the outer door skin can comprise folding over the at least one tab in order thereby to fix the assembly comprising the outer door skin relative to the inner door panel by means of a compressive force between the at least one tab of the assembly comprising the outer door skin and the inner door panel.

That is to say that the door bodyshell can, in particular as an alternative to the above-described one-sided joining, be fastened to the inner door panel by means of the tabs for prefixing the assembly comprising the outer door skin, until the adhesive is cured.

It is contemplated here that the at least one tab is folded over by means of a tool through a window well arranged between the assembly comprising the outer door skin and the inner door panel.

Irrespective of whether prefixing is achieved with the tabs or by one-sided joining, the method can comprise connection of the further three sides of the assembly to the inner door panel by flanging. The three further sides comprise a respective lower edge of the inner door panel and of the assembly comprising the outer door skin and also the respective front or rear edge of the inner door panel and of the assembly comprising the outer door skin. Here, these three further or remaining sides of the outer door skin, that is to say the two outer edges in the motor vehicle longitudinal direction and the lower edge of the outer door skin in the motor vehicle vertical direction that is situated in the entry region of the side door, can be placed or bent around the inner door panel in the manner described above. Additionally or alternatively, welding of the three further sides can occur.

The invention will be described in detail below with reference to FIGS. 1 to 4, with this description of the figures relating to two specific embodiments which are explained only by way of example and are not to be deemed as limiting.

### BRIEF DESCRIPTION OF THE DRAWINGS

FIG. 1 schematically shows a beltline region of a door bodyshell of a framed door of a motor vehicle in a section through a plane to which a motor vehicle longitudinal direction is perpendicular;

FIG. 2 schematically shows a flow diagram of a production method for the door bodyshell partially illustrated in FIG. 1;

FIG. 3 schematically shows the door bodyshell in the progression of the production method according to a first embodiment of the production method; and

FIG. 4 schematically shows the door bodyshell in the progression of the production method according to a second embodiment of the production method.

In the following description of the figures, the same reference signs are used for identical elements in the figures even if they relate to different embodiments. Moreover, the aspects described in relation to the respective embodiments can be combined insofar as the embodiments do not explicitly propose a different solution for one of these aspects.

### DETAILED DESCRIPTION OF THE DRAWINGS

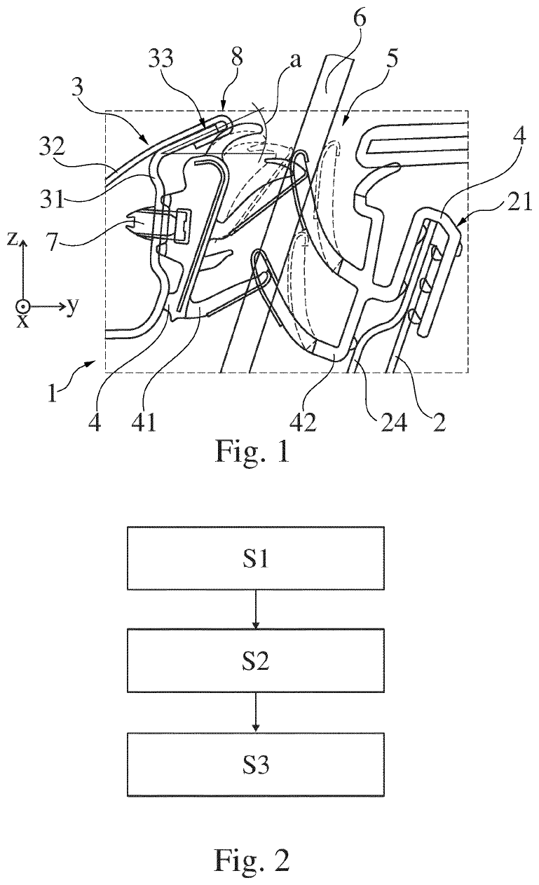

FIG. 1 illustrates a Cartesian coordinate system comprising an X axis pointing in the motor vehicle longitudinal direction, a Y axis pointing in the motor vehicle width direction and a Z axis pointing in the motor vehicle vertical direction.

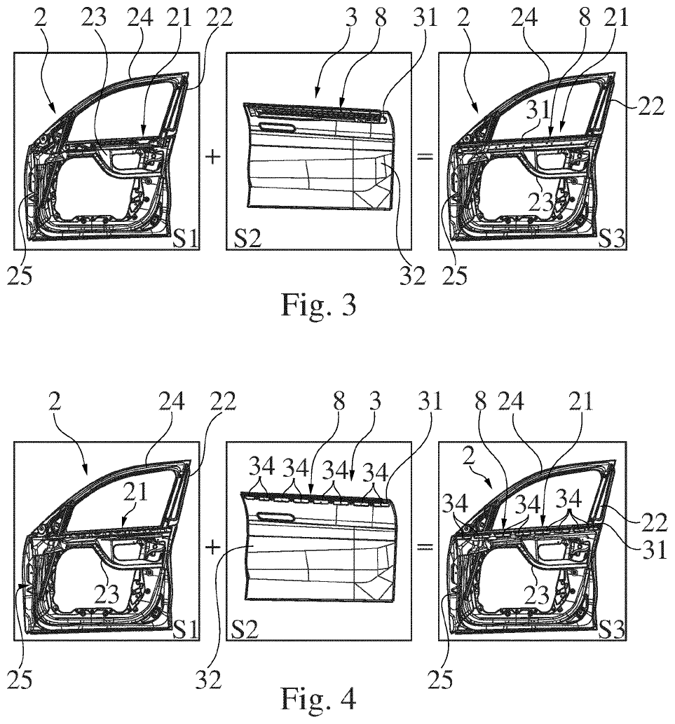

Here, FIG. 1 shows a section or cross section through a door bodyshell 1 of a framed door (see also FIGS. 3 and 4) of a motor vehicle (not shown) in a beltline region of the door bodyshell 1.

The door bodyshell 1 comprises an inner door panel 2 having a closure panel 24; an assembly 3 which is fastened to the inner door panel 2 and which comprises a reinforcing structure or a reinforcing panel 31 and an outer door skin 32; and a seal 4 which is arranged in a window well 5 formed between the inner door panel 2 and the assembly 3 and is in sealing contact with a window pane 6.

The seal 4 is configured in two parts, wherein an outer part 41, or left part in FIG. 1, of the seal 4, which can also be referred to as a well covering for the window well 5, can be mounted in the motor vehicle width direction Y. More specifically, in the present case, this outer part 41 of the seal 4 is fixed to the reinforcing panel 31 via a clip 7, with other fastening means, such as, for example a screw, also being conceivable. An inner part 42, or right part in FIG. 1, of the seal 4 is plugged onto the inner door panel 2. The two parts 41, 42 are each in contact with the window pane 6 when this is installed, as is indicated by the dashed lines in FIG. 1. The seal 4 is thus in sealing contact with the window pane 6, wherein, in this state, the outer part 41 of the seal 4 closes, in particular seals, the window well 5 in the outer beltline region 8, with the result that no dirt can get into the window well 5 from outside.

The inner door panel 2 has an inner beltline region 21 and a peripheral frame structure 22 (see FIGS. 3 and 4), which is connected to the inner beltline region 21, for the motor vehicle side window 6.

The reinforcing structure 31 of the assembly 3 is arranged level with the inner beltline region 21 and is connected to the outer door skin 32 level with the inner beltline region 21 by means of a flange 33.

Here, FIG. 1 shows, with respect to the motor vehicle longitudinal direction X, the motor vehicle width direction Y and the motor vehicle height direction Z, a state in which the door bodyshell 2 is installed on the motor vehicle.

In this state, the flange 33 arranged level with the inner beltline region 21, that is to say the reinforcing structure 31 and the part of the outer door skin 32 that is bent through at least 180° around the reinforcing structure 31, is inclined in the direction of a motor vehicle interior. In the present case, the flange 33 and a horizontal or an XY plane, to which the motor vehicle vertical direction Z is perpendicular, therefore enclose an angle α of less than 90°, more specifically an angle of between 45° and 60°.

In the state illustrated in FIG. 1, that is to say in the state in which the door bodyshell 1 is installed on the motor vehicle, the outer door skin 32 upwardly delimits an outer beltline region 8, that is to say a beltline region arranged to the left of the window pane 6 in FIG. 1, in a motor vehicle vertical direction Z.

The reinforcing structure 31 of the assembly 3 is shorter than the outer door skin 32 in the motor vehicle longitudinal direction X (see in this respect in particular FIGS. 3 and 4, central window). By contrast, the flange 33 extends into both outer corners, in the motor vehicle longitudinal direction X, of the inner beltline region 21 (see in this respect in particular FIGS. 3 and 4, central window). Particularly how the latter can be achieved will be described in detail below with reference to FIGS. 2 to 4.

As can be seen from FIG. 2, which illustrates a schematic flow diagram for the above-described door bodyshell 1, the method substantially comprises three steps S1-S3. These three steps S1-S3 are each illustrated in FIGS. 3 and 4, wherein a first window from the left in FIGS. 3 and 4 corresponds to a first step S1 of the method, a second window from the left in FIGS. 3 and 4 corresponds to a second step S2 of the method, and a third window from the left in FIGS. 3 and 4 corresponds to a third step S3 of the method.

In the first step S1 of the method, the above-described inner door panel 2 is provided as a first assembly part, which, in addition to the inner door panel 2, comprises a reinforcing structure 23 welded thereto for the outer door skin 32, a hinge carrier 25, which is arranged here in a region of an A-pillar, and the closure panel 24. As can be seen from FIGS. 3 and 4, this is identical in both embodiments of the production method. However, the reinforcing structure 23 for the outer door skin 32 of the first embodiment illustrated in FIG. 3, which can also be referred to as a screwing/adhesive bonding solution, differs from the second embodiment illustrated in FIG. 4, which can also be referred to as an adhesive bonding/tab solution, in that the reinforcing structure 23 for the outer door skin 32 in the first embodiment, and by contrast with the second embodiment, does not extend up to the inner beltline region 21. By contrast, the reinforcing structure 23 for the outer door skin 32 of the second embodiment illustrated in FIG. 4 extends up to the inner beltline region 21 and is thus higher in the motor vehicle longitudinal direction Z than the reinforcing structure 23 for the outer door skin 32 of the first embodiment illustrated in FIG. 3.

In a second step S2 of the method, the above-described assembly 3 comprising the reinforcing structure 31 for the outer beltline region 8 and the outer door skin 32 is provided. This comprises, in both embodiments, flanging of the outer door skin 32 around the reinforcing structure 31 for the outer beltline region 8 in order thereby to obtain the flange 33 described above in detail with reference to FIG. 1. However, in the first embodiment, a relining adhesive is provided in order to fix the outer door skin 32 and the reinforcing structure 31 for the outer beltline region 8 laterally to one another. That is to say that, in the first embodiment, the provision of the assembly comprises providing an adhesive between the outer door skin 32 and the reinforcing structure 31 for the outer beltline region 8 in the region of the flange 33. In the second embodiment, flanged edge fixing is carried out by means of laser welding in order to fix the outer door skin 32 and the reinforcing structure 31 for the outer beltline region 8 laterally to one another. That is to say that, in the second embodiment, the provision of the assembly 3 comprises providing flanged edge fixing, in particular at both outer ends of the reinforcing structure 31 in the motor vehicle longitudinal direction X.

In a third step S3 of the method, the assembly provided in the first step S1 and comprising, inter alia, the inner door panel 2 is connected to the assembly 3 provided in the second step S2 and comprising the outer door skin 32 and the reinforcing structure 31 for the outer beltline region 8. The outer door skin 32 is not illustrated in the respective third window from the left in FIGS. 3 and 4. In both embodiments, the connection comprises first of all applying an adhesive to the inner door panel 2 and/or the assembly 3 level with the inner beltline region 21, and then joining the assembly 3 to the inner door panel 2 such that the assembly 3 is fixed relative to the inner door panel 2 until the adhesive is cured and the assembly 3 comprising the outer door skin 32 is also fastened to the inner door panel 2 by means of an adhesive bond. In the first embodiment, the joining comprises one-sided joining, here screwing, wherein the inner door panel 2 has openings such that the screws (not shown) for the one-sided joining can be reached through the openings. The screwing can occur on an A-pillar or C-pillar and a B-pillar for fixing the adjacent adhesive between the closure panel 24 of the door bodyshell 2 and the reinforcing structure 31 for the outer beltline region 8 and between the reinforcing structure 31 for the outer beltline region 8 and the hinge carrier 25. The screwing can also occur through an opening between the reinforcing structure 31 for the outer beltline region 8 and the reinforcing structure 23 for the outer door skin 32. In the second embodiment, the reinforcing structure 31 for the outer beltline region 8 comprises a plurality of tabs 34, as is illustrated in FIG. 4. The inner door panel 2 is connected to the assembly 3 by folding over the tabs 34, which are inserted into beads and pockets, which are provided for the tabs 34, of the reinforcing structure 23 for the outer door skin 32 in order thereby to fix the assembly 3 relative to the inner door panel 2 by means of a compressive force between the tabs 34 of the assembly 3 and the reinforcing structure 23 for the outer door skin 32. Here, the tabs 34 are folded over by means of a tool through the window well 5 arranged between the assembly 3 and the inner door panel 2 (see FIG. 1).

In the above-described embodiments, the flange 33 is proposed for connecting the reinforcing structure 32 for the outer beltline region 8 to the outer door skin 32. As an alternative to the flange 33, the reinforcing structure 31 for the outer beltline region 8 can be or have been connected to the outer door skin 32 by a welded joint.

### LIST OF REFERENCE SIGNS

1 door bodyshell
2 inner door panel
21 inner beltline region
22 frame structure
23 reinforcing structure for outer door skin
24 closure panel
25 hinge carrier
3 assembly comprising the outer door skin
31 reinforcing structure for the outer beltline region
32 outer door skin
33 flange
34 tabs
4 seal
41 outer part of the seal or well covering
42 inner part of the seal
5 window well
6 window pane
7 clip
8 outer beltline region
α angle between flange and horizontal plane
S1-S3 steps of the method

1.-10. (canceled)

11. A door bodyshell of a framed door of a motor vehicle, comprising:
an inner door panel comprising an inner beltline region and a peripheral frame structure, which is connected to the inner beltline region, for a motor vehicle side window; and
an assembly, which is fastened to the inner door panel, having a reinforcing structure, which is arranged level with the inner beltline region, and an outer door skin, which is connected to the reinforcing structure level with the inner beltline region via a flange or a welded joint, wherein,
in a state in which the door bodyshell is installed on the motor vehicle, the reinforcing structure is inclined level with the inner beltline region in the direction of a motor vehicle interior such that the flange or the welded joint and a horizontal plane enclose an angle of less than 90°, and
in the state in which the door bodyshell is installed on the motor vehicle, the flange or the welded joint is formed as far as at least an outer corner, in the motor vehicle longitudinal direction, of an outer beltline region of the door bodyshell.

12. The door bodyshell according to claim 11, wherein,
in the state in which the door bodyshell is installed on the motor vehicle, the outer door skin upwardly delimits the outer beltline region in a motor vehicle vertical direction, and/or
in the state in which the door bodyshell is installed on the motor vehicle, the reinforcing structure is shorter than the outer door skin in the motor vehicle longitudinal direction.

13. The door bodyshell according to claim 11, further comprising:
a seal which can be brought into sealing contact with a window pane, and, in the state in which the seal is in sealing contact with the window pane, closes a window well in the outer beltline region.

14. A production method for a door bodyshell, the method comprising:
providing an inner door panel comprising an inner beltline region and a peripheral frame structure, which is connected to the inner beltline region, for a motor vehicle side window;
providing an assembly having a reinforcing structure, which is arrangable level with the inner beltline region, and an outer door skin, which is connectable to the reinforcing structure level with the inner beltline region via a flange or a welded joint; and
fastening the assembly to the inner door panel such that:
in a state in which the door bodyshell is installed on the motor vehicle, the reinforcing structure is inclined level with the inner beltline region in the direction of a motor vehicle interior such that the flange or the welded joint and a horizontal plane enclose an angle of less than 90°, and
in the state in which the door bodyshell is installed on the motor vehicle, the flange or the welded joint is formed as far as at least an outer corner, in the motor vehicle longitudinal direction, of an outer beltline region of the door bodyshell.

15. The production method according to claim 14, wherein the providing of the assembly comprises flanging the outer door skin around the reinforcing structure or welding the outer door skin to the reinforcing structure with the formation of a welded joint.

16. The production method according to claim 15, wherein the providing of the assembly comprises providing an adhesive between the outer door skin and the reinforcing structure in the region of the flange or the welded joint, and/or providing a flanged edge fixing.

17. The production method according to claim 14, wherein the connection of the inner door panel to the assembly comprises:
applying an adhesive to the inner door panel and/or the assembly level with the inner beltline region;
joining the assembly to the inner door panel such that the assembly is fixed relative to the inner door panel until the adhesive is cured and the assembly is fastened to the inner door panel via an adhesive bond.

18. The production method according to claim 17, wherein
the joining comprises one-sided joining and the inner door panel has at least one opening sized such that a joining device for the one-sided joining is reachable through the at least one opening.

19. The production method according to claim 17, wherein
the reinforcing structure comprises at least one tab and the connection of the inner door panel to the assembly comprises folding over the at least one tab in order thereby to fix the assembly relative to the inner door panel by a compressive force between the at least one tab of the assembly and the inner door panel.

20. The production method according to claim 19, wherein
the at least one tab is folded over by a tool through a window well arranged between the assembly and the inner door panel.
